(19) United States
(12) Patent Application Publication
(10) Pub. No.: US 2017/0139605 A1
(43) Pub. Date: May 18, 2017

(54) CONTROL DEVICE AND CONTROL METHOD

(71) Applicant: FUJITSU LIMITED, Kawasaki-shi (JP)

(72) Inventors: Tatsuya SHINOZAKI, Kawasaki (JP); TAKANORI ISHll, Nerima (JP); Tomoyuki Kanayama, Kawasaki (JP)

(73) Assignee: FUJITSU LIMITED, Kawasaki-shi (JP)

(21) Appl. No.: 15/347,435

(22) Filed: Nov. 9, 2016

(30) Foreign Application Priority Data
Nov. 17, 2015 (JP) 2015-224908

(51) Int. Cl. G06F 3/06; G06F 13/24

(52) U.S. Cl. CPC G06F 3/065; G06F 3/0619; G06F 3/0643; G06F 3/0659; G06F 3/0683; G06F 13/24

(57) ABSTRACT

A control device includes a first memory, a first processor coupled to the first memory, a second memory, and a second processor coupled to the second memory. The first processor is configured to store log information of an information processing device into the first memory. The second processor is configured to determine whether the log information is stored in the first memory. The second processor is configured to read the log information from the first memory when the second processor determines that the log information is stored in the first memory. The second processor is configured to write the read log information into the second memory.

### CROSS-REFERENCE TO RELATED APPLICATION

This application is based upon and claims the benefit of priority of the prior Japanese Patent Application No. 2015-224908 filed on Nov. 17, 2015, the entire contents of which are incorporated herein by reference.

### FIELD

The embodiment discussed herein is related to a control device and a control method.

### BACKGROUND

In an information processing device such as a storage device, a server device, and the like, in response to a demand for high functionality, the spread of a multicore central processing unit (CPU) or a virtual environment through hypervisor is progressing. Therefore, the amount of log information stored for the information processing device has increased several times as compared to the amount in past days.

For example, a storage device may include controller modules (CM) each including a CPU and a memory, in a redundant manner in order to manage the storage device. At a normal operation of the storage device, log information about the storage device is stored in a memory by firmware (FW) embedded in the CM. The log information stored in the memory is written by the FW in a non-volatile recording medium such as a solid state drive (SSD) at a certain timing, and transferred to and written in a non-volatile recording medium of a redundant counterpart CM. Accordingly, the log information is duplicated to be stored in a pair of CMs.

Related techniques are disclosed in, for example, Japanese Laid-Open Patent Publication No. 5-88947, Japanese Laid-Open Patent Publication No. 2009-9213, Japanese Laid-Open Patent Publication No. 2015-11524, Japanese National Publication of International Patent Application No. 2015-515047, and Japanese Laid-Open Patent Publication No. 2015-138306.

As described above, the write control of log information in the CM is performed by the FW embedded in the CM. Thus, when a CM abnormality such as CPU hang-up occurs, the FW does not operate. Accordingly, the log information of abnormal CMs, which is required for analysis or the like of the CM abnormalities, is unable to be transferred from the memory to a non-volatile recording medium or a CM as the redundant counterpart.

### SUMMARY

According to an aspect of the present invention, provided is a control device including a first memory, a first processor coupled to the first memory, a second memory, and a second processor coupled to the second memory. The first processor is configured to store log information of an information processing device into the first memory. The second processor is configured to determine whether the log information is stored in the first memory. The second processor is configured to read the log information from the first memory when the second processor determines that the log information is stored in the first memory. The second processor is configured to write the read log information into the second memory.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a hardware configuration of a storage device including control devices according to an embodiment;

FIG. 2 is a diagram illustrating an example of a functional configuration of a control device according to an embodiment;

FIG. 3 is a diagram illustrating a specific example of a table (a first table) that associates a log type with a log importance according to an embodiment;

FIG. 4 is a diagram illustrating a specific example of a table (a second table) that associates a log importance with a write technique according to an embodiment;

FIG. 5 is a flowchart illustrating an operation of a control device according to an embodiment;

FIG. 6 is a flowchart illustrating an operation of a control device according to an embodiment;

FIG. 7 is a flowchart illustrating an operation of a control device according to an embodiment;

FIG. 8 is a diagram illustrating a flow of a log in a comparative technology;

FIG. 9 is a diagram illustrating a flow of a log with rank #1 according to an embodiment;

FIG. 10 is a diagram illustrating a flow of a log with rank #2 according to an embodiment;

FIG. 11 is a diagram illustrating a flow of a log with rank #3 according to an embodiment; and

FIG. 12 is a diagram illustrating a flow of a log with rank #4 according to an embodiment.

### DESCRIPTION OF EMBODIMENT

Hereinafter, an embodiment of a control device and a control method disclosed in the present disclosure will be described in detail with reference to the accompanying drawings. The embodiment described below is illustrative only and is not intended to exclude various modifications and applications of techniques not specified in the embodiment. That is, the present embodiment may be modified in various ways without departing from the spirit thereof. There is no gist that each drawing includes only the components illustrated in the drawing while the drawing may further include other functions. Then, the modified embodiments may be appropriately combined within a range in which the processing contents are not contradictory.

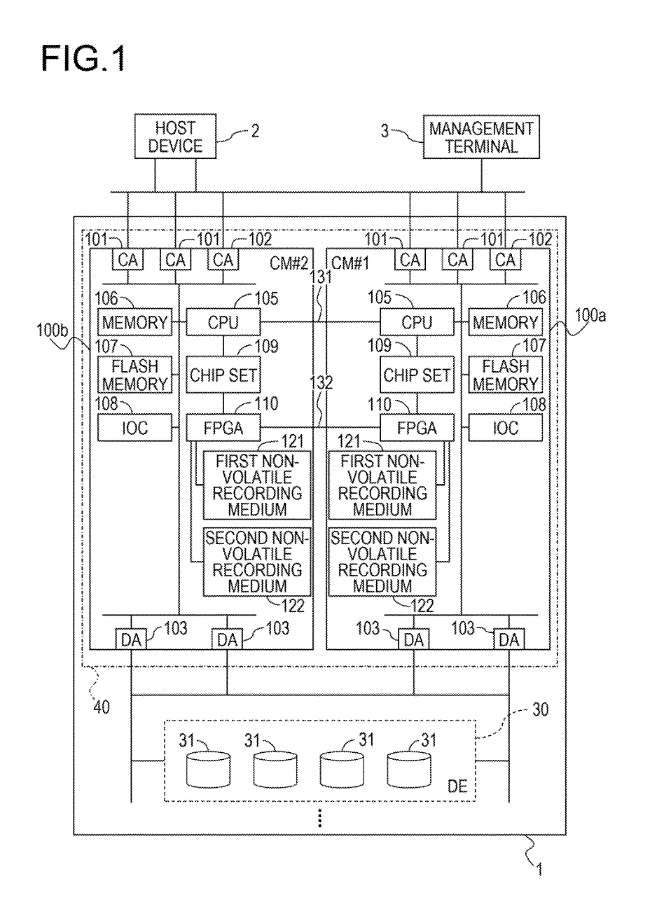

First, with reference to FIG. 1, descriptions will be made on a hardware configuration of a storage device 1 (a storage system, an information processing device) including storage control devices 100 (control devices) according to the present embodiment. FIG. 1 is a diagram illustrating an example of a hardware configuration of the storage device 1 including the storage control devices 100 according to the present embodiment.

The storage device 1 virtualizes memory devices 31 stored in a drive enclosure (DE) 30 to form a virtual storage environment. Then, the storage device 1 provides a virtual volume to a host device 2 (a server) that is an upper level device.

The storage device 1 is communicably coupled to one or more host devices 2 (one host device in the example illustrated in FIG. 1). The host device 2 and the storage device 1 are coupled via communication adapters (CA) 101 and 102 to be described below.

The host device 2 is, for example, an information processing device having a server function, and transmits and receives commands of a network attached storage (NAS) or a storage area network (SAN) to/from the storage device 1. The host device 2 transmits, for example, storage access commands of the NAS, such as write/read and the like, to the storage device 1, thereby writing or reading data to/from a volume provided by the storage device 1.

Then, the storage device 1 performs a processing such as writing or reading of data to/from a memory device 31 corresponding to the volume in response to an input/output request (e.g., a write request or a read request) performed on the volume from the host device 2. In the following, an input/output request from the host device 2 may be referred to as an I/O request.

A management terminal 3 is communicably coupled to the storage device 1. The management terminal 3 is an information processing device including an input device such as a keyboard, a mouse, and the like, and a display device, through which a user such as a system administrator performs input operations of various information. For example, the user inputs information on various settings or the like through the management terminal 3. The input information is transmitted to the host device 2 or the storage device 1.

The storage device 1, as illustrated in FIG. 1, includes a plurality (two in the present embodiment) of CMs 100a and 100b and one or more (one in the example illustrated in FIG. 1) DEs 30.

The DE 30 may be equipped with one or more (four in the example illustrated in FIG. 1) memory devices 31 (physical disks), and provides a storage area (an actual volume, an actual storage) of these memory devices 31 to the storage device 1.

For example, the DE 30 may include a plurality of slots (not illustrated) such that the memory devices 31 may be mounted in these slots, thereby changing an actual volume capacity at any time. A redundant array of inexpensive disks (RAID) may be constituted by the plurality of memory devices 31.

The memory device 31 is a memory device (a storage device) such as a hard disk drive (HDD), an SSD, or the like that is larger in capacity than a memory 106 to be described below, and is configured to store therein various data. Hereinafter, the memory device may be referred to as a drive or a disk.

Each DE 30 is coupled to each of device adapters (DAs) 103 of the CM 100a and DAs 103 of the CM 100b. Each DE 30 may be accessed by any of the CMs 100a and 100b so that data is written or read. That is, the respective memory devices 31 of the DE 30 are coupled to each of the CMs 100a and 100b, thereby making access paths to the memory devices 31 redundant.

A controller enclosure (CE) 40 includes one or more (two in the example illustrated in FIG. 1) CMs 100a and 100b.

The CMs 100a and 100b are control devices (controllers, storage control devices) configured to control the operation within the storage device 1, and perform various controls such as control of data access to the memory devices 31 of the DE 30 in response to an I/O request transmitted from the host device 2. The CMs 100a and 100b have a similar configuration. Hereinafter, an arbitrary CM between the CMs 100a and 100b may be referred to as a CM 100. The CM 100a may be referred to as a CM #1, and the CM 100b may be referred to as a CM #2, respectively.

The CMs 100a and 100b are duplicated, and in general, the CM 100a (CM #1) is primary and performs various controls. However, when the primary CM 100a is failed, a secondary CM 100b (CM #2) becomes primary and takes over the operation of the CM 100a.

Each of the CMs 100a and 100b is coupled to the host device 2 through the CAs 101 and 102. Then, each of the CMs 100a and 100b receives an I/O request such as read/write or the like transmitted from the host device 2, and performs a control of the memory devices 31 through the DAs 103. The CMs 100a and 100b are communicably coupled to each other via an interface (communication paths 131 and 132 to be described below) such as a peripheral component interconnect express (PCIe) or the like.

The CM 100 includes, as illustrated in FIG. 1, the CAs 101 and 102 and a plurality (two in the example illustrated in FIG. 1) of DAs 103, and further includes a CPU 105, a memory 106, a flash memory 107 and an input output controller (IOC) 108. The CAs 101 and 102, the DAs 103, the CPU 105, the memory 106, the flash memory 107, and the IOC 108 are communicably coupled to each other through, for example, a PCIe interface.

The CPU 105 of the CM 100 is coupled to a monitor-control flexible programmable gate array (FPGA) 110 through a chip set 109. The FPGA 110 is coupled to two kinds of non-volatile recording media 121 and 122 (to be described below) having different performances.

The CAs 101 and 102 are adapters that receive data transmitted from the host device 2, the management terminal 3, or the like, or transmit data output from the CM 100 to the host device 2, the management terminal 3, or the like. That is, the CAs 101 and 102 control the input/output of data from/to an external device such as the host device 2 or the like.

The CA 101 is a network adapter communicably coupled to the host device 2 or the management terminal 3 through the NAS, and is, for example, a local area network (LAN) interface or the like. Each CM 100 is coupled to the host device 2 or the like through the NAS by the CA 101 via a communication line (not illustrated), and performs reception of an I/O request, transmission/reception of data, or the like. In the example illustrated in FIG. 1, each of the CMs 100a and 100b is provided with two CAs 101.

The CA 102 is a network adapter communicably coupled to the host device 2 through the SAN, and is, for example, an internet small computer system interface (iSCSI) or a fibre channel (FC) interface. Each CM 100 is coupled to the host device 2 or the like through the SAN by the CA 102 via a communication line (not illustrated), and performs reception of an I/O request, transmission/reception of data, or the like. In the example illustrated in FIG. 1, each of the CMs 100a and 100b is provided with one CA 102.

The DA 103 is an interface configured to be communicably coupled to the DE 30, the memory devices 31, or the like. The DA 103 is coupled to the memory devices 31 of the DE 30, and each CM 100 performs a control of access to the memory devices 31 on the basis of an I/O request received from the host device 2.

Each CM 100 performs writing or reading of data to/from the memory devices 31 through the DAs 103. In the example illustrated in FIG. 1, each of the CMs 100a and 100b is provided with two DAs 103. In each of the CMs 100a and 100b, each DA 103 is coupled to the DE 30.

Accordingly, on the memory devices 31 of the DE 30, writing or reading of data may be performed by any one of the CMs 100a and 100b.

The flash memory 107 is a memory device that stores therein programs to be executed by the CPU 105 or stores various data.

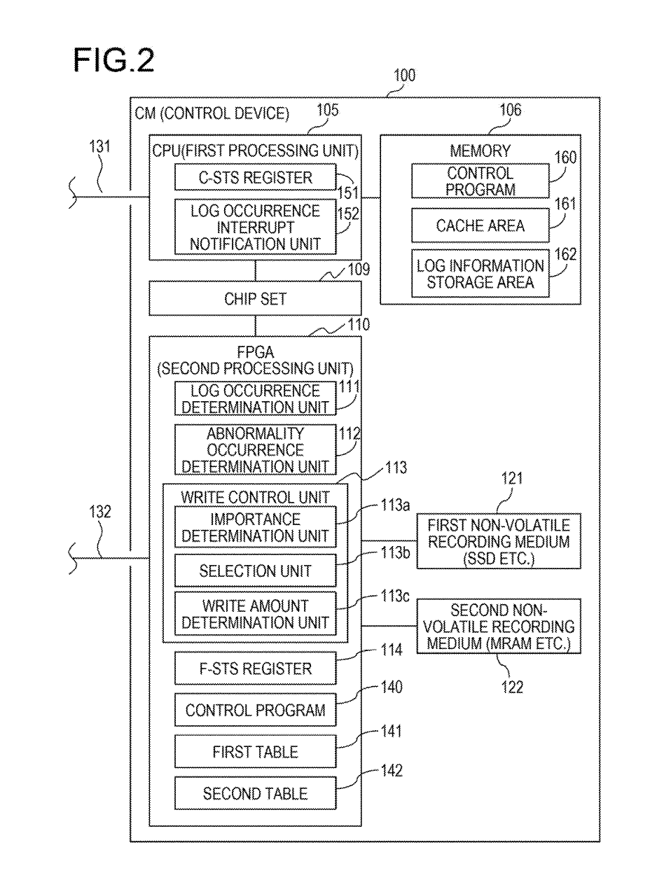

The memory 106 (a main memory, a first memory area) is a memory device that temporarily stores therein various data or programs, and not only stores a control program 160, but also includes a cache area 161 or a log information storage area 162 (see FIG. 2). The control program 160 is a program executed by the CPU 105 so that, for example, a control function according to the present embodiment (e.g., a function as a log occurrence interrupt notification unit 152 as illustrated in FIG. 2), and is stored in the memory 106 or the flash memory 107. The cache area 161 temporarily stores therein the data received from the host device 2, or the data to be transmitted to the host device 2. The log information storage area 162 temporarily memorizes and stores various log information occurring in the storage device 1 including the CM 100. The memory 106 is a random access memory (RAM) or the like that is faster in an access speed but smaller in a capacity than the above-described memory device 31 (a drive).

The IOC 108 is a control device that controls data transmission within each CM 100, and implements, for example, direct memory access (DMA) transmission in which data stored in the memory 106 is transmitted without passing through the CPU 105.

The CPU 105 is a processing device (a first processing unit) that performs various controls or calculations, and is, for example, a multi-core processor (a multi-core CPU). The CPU 105 executes an operating system (OS) or a program stored in the memory 106, the flash memory 107 or the like, thereby achieving various functions. Particularly, in the present embodiment, the CPU 105 executes the control program 160, thereby performing the function as the log occurrence interrupt notification unit 152 to be described below (see FIG. 2).

Two communication paths 131 and 132 are provided between the two CMs 100a and 100b which are redundant.

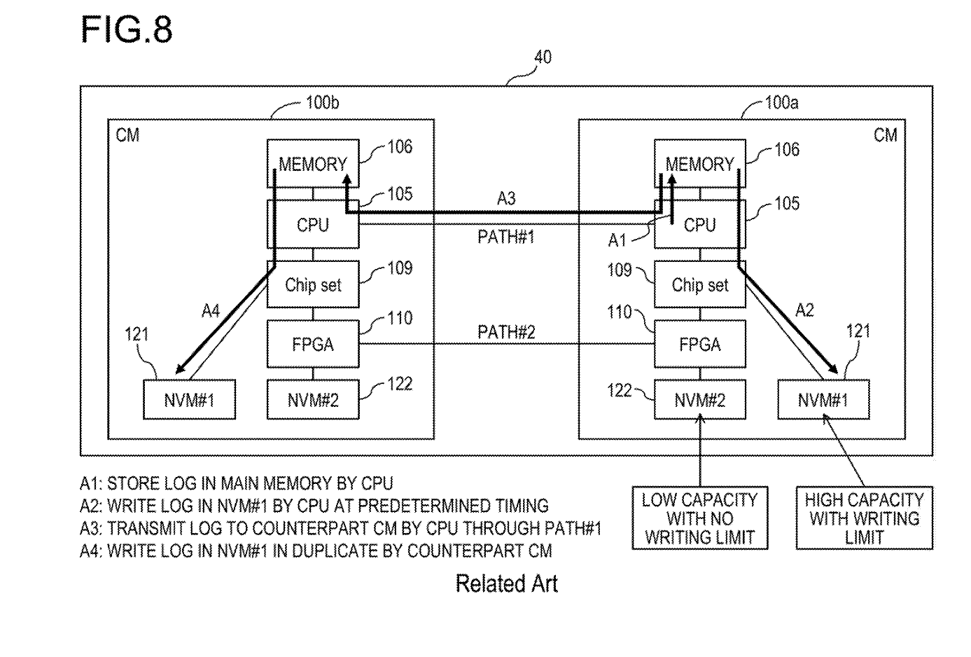

The first communication path 131 is an inter-CPU communication path (which may be referred to as path #1) that interconnects the CPU 105 of the CM 100a and the CPU 105 of the CM 100b. The first communication path 131 is capable of performing high-capacity communication at a high speed, and is used for exchanging user data between the CMs 100. In the comparative technology to be described below with reference to FIG. 8, the first communication path 131 is also used for exchanging the log information between the CPUs 105 so that the log information is duplicated. In contrast, in the present embodiment, the first communication path 131 is used for exchanging the user data between the CMs 100, but is not used for exchanging the log information between the CMs 100.

The second communication path 132 is an inter-FPGA communication path (which may be referred to as path #2) that interconnects the FPGA 110 of the CM 100a and the FPGA 110 of the CM 100b. The second communication path 132 is used for exchanging monitor-control information of the storage device 1 between the monitor-control FPGAs 110. In the comparative technology to be described below with reference to FIG. 8, the second communication path 132 is used only for exchanging the monitor-control information between the FPGAs 110. In contrast, in the present embodiment, the second communication path 132 is used for not only exchanging the monitor-control information between the CMs 100, but also exchanging the log information between the CMs 100 so that the log information is duplicated.

In each CM 100, the chip set 109, the FPGA 110, and the non-volatile recording media 121 and 122 perform a monitor control function of the storage device 1.

The chip set 109 manages the transfer of data between the CPU 105 and the FPGA 110.

The FPGA 110 is a processing device (a second processing unit) that performs a monitor control of the storage device 1. In the FPGA 110 of the present embodiment, a control program 140, a first table 141, and a second table 142 are embedded (see FIG. 2). The FPGA 110 executes the control program 140 to implement the monitor control function of the storage device 1. The FPGA 110 determines an importance (rank) of log information with reference to the first table 141 and the second table 142 as described below.

A first non-volatile recording medium 121 (a second memory area) records, memorizes, and stores the log information read from the memory 106. The first non-volatile recording medium 121 is a medium (e.g., a medium having a write limit count equal to or less than a predetermined number) that is capable of storing therein a large amount of data but has a write life limit, and is, for example, an SSD or a universal serial bus (USB) memory. In the comparative technology to be described below with reference to FIG. 8, writing of log information in the first non-volatile recording medium 121 is performed through the chip set 109 by the CPU 105 (FW). In contrast, in the present embodiment, writing of log information in the first non-volatile recording medium 121 is performed by the FPGA 110 as described below. In the present embodiment, the log information read from a second non-volatile recording medium 122 may be written in the first non-volatile recording medium 121 by the FPGA 110, as described below. In the following, the first non-volatile recording medium 121 may be referred to as a NVM #1. The NVM is an abbreviation of a non-volatile memory.

The second non-volatile recording medium 122 (a second memory area) records, memorizes, and stores monitor-control information exchanged between FPGAs 110 through the second communication path 132. The second non-volatile recording medium 122 is a medium that has a small capacity but has substantially no write life limit (e.g., a medium having a write limit count higher than a predetermined number), and is, for example, a magnetoresistive random access memory (MRAM). In the comparative technology to be described below with reference to FIG. 8, only the monitor-control information is written in the second non-volatile recording medium 122 by the FPGA 110. In contrast, in the present embodiment, not only monitor-control information is written by the FPGA 110 in the second non-volatile recording medium 122 but also log information read from the memory 106 is written. In the following, the second non-volatile recording medium 122 may be referred to as NVM #2.

Here, descriptions will be made on the technology to be compared to the present embodiment, and an outline of the present embodiment with reference to FIG. 8. FIG. 8 is a diagram illustrating a flow of a log in the comparative technology.

In the storage device 1 (see FIG. 1), when an occurrence of log information is detected by the CPU 105 of the CM 100a, the log information is temporarily stored in the log information storage area 162 in the memory 106 (see FIG. 2) by the CPU 105 (FW) of the CM 100a (A1 in FIG. 8). Then, in the CM 100a, the log information stored in the memory 106 is finally written and stored in the NVM #1 from the memory 106 via the chip set 109 by the CPU 105 (FW) of the CM 100a (A2 in FIG. 8).

Also, the log information stored in the memory 106 is transmitted to the CPU 105 (FW) of the CM 100b via the first communication path 131 by the CPU 105 (FW) of the CM 100a, and written in the memory 106 of the CM 100b (A3 in FIG. 8). Then, in the CM 100b, the log information stored in the memory 106 is finally written and stored in NVM #1 from the memory 106 via the chip set 109 by the CPU 105 (FW) of the CM 100b (A4 in FIG. 8). In this manner, the log information of the storage device 1 is duplicated and stored in the NVM #1 in each of the two CMs 100 using the first communication path 131.

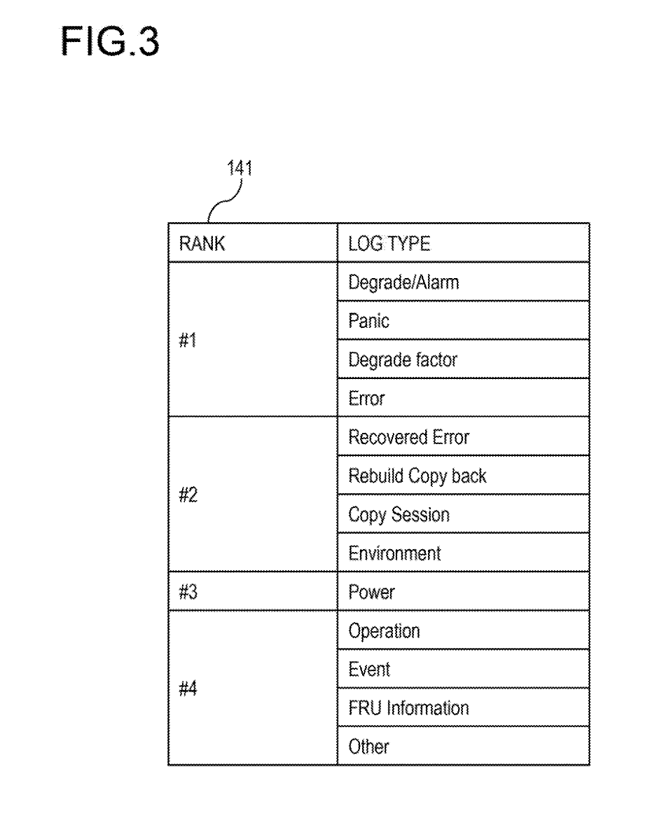

In the above-described comparative technology, the writing of log information in the NVM #1 is performed by the CPU 105 (FW) periodically (e.g., every five minutes) or at a power-off/on timing of the storage device 1 in order to cope with an unexpected accident in the storage device 1. As for the log information to be written, for example, thirteen types of log information illustrated in FIG. 3 may be exemplified.

The writing of log information in the NVM #1 is managed for each page obtained by dividing a log information storage area of the NVM #1 by a predetermined size. That is, writing of log information is performed for each page with a predetermined size allocated in accordance with the type of log information. When the write amount of the log information reaches the capacity limit of the page, a new page is allocated, and then writing of log information is performed on the newly allocated page.

By performing the control of a write timing or a management of a write area as described above, the number of times of writing in the first non-volatile recording medium 121 that stores therein log information may be suppressed from exceeding a write limit count (that is, a write life limit) within a lifetime of the storage device 1. However, in the comparative technology illustrated in FIG. 8, the following situations (1) to (3) may occur.

(1) The first non-volatile recording medium 121 such as an SSD, a USB memory, or the like has a write life limit as described above. The capacity of all of log information occurring within the lifetime of the storage device 1 is relatively large. Thus, it is required to perform a write control of log information in the first non-volatile recording medium 121 so that all of log information may be stored in the first non-volatile recording medium 121.

(2) The abnormality occurrence determination in the storage device 1 including the CM 100 is performed by the monitor-control FPGA 110, but the write control of the log information is performed by the CPU 105 (FW). Thus, when a CM abnormality such as CPU hang-up occurs, the FW is not executed. Therefore, the log information of an abnormal CM 100, which is required for analysis or the like of the CM abnormality, is unable to be acquired from the memory 106 to the first non-volatile recording medium 121, or transmitted to the CM as the redundant counterpart.

(3) In general, the latest log information is stored in the main memory 106, and the writing of log information in the first non-volatile recording medium 121 is performed periodically or at a power-off/on timing of the storage device 1 by the CPU 105 (FW) as described above. Thus, when the storage device 1 is turned off or rebooted, a processing of writing the log information (log saving) from the main memory 106 to the first non-volatile recording medium 121 occurs. Due to the time required for the log saving, the processing of turning off the storage device 1 or the processing of restoring the storage device 1 may be prolonged.

Therefore, while the write control of log information is realized through the execution of firmware by the CPU 105 in the comparative technology, the write control is performed by the monitor-control FPGA 110 in the present embodiment. That is, while the FPGA 110 handles only the monitor-control information in the comparative technology, the FPGA 110 performs a write control of log information as well as a monitor control on the basis of the monitor-control information in the present embodiment. Also, in the present embodiment, two kinds of non-volatile recording media 121 and 122 having different performances are configured to be separately used in accordance with the types (importance) of log information.

For example, in order to cope with the situation (1), the FPGA 110 according to the present embodiment determines the type of log information, determines the importance of the log information in accordance with the type, and controls a write technique or a write destination of the log information in accordance with the importance.

In order to cope with the situations (2) and (3), the FPGA 110 according to the present embodiment detects an abnormality on the basis of monitor-control information of monitor-control performed by itself when the abnormality occurs, reads the log information from the main memory 106, and writes the log information in the non-volatile recording medium 121 or 122. When receiving a notification of an occurrence of log information (writing of log information in the main memory 106) from the CPU 105, the FPGA 110 according to the present embodiment reads the log information written in the main memory 106, and writes the log information in the non-volatile recording medium 121 or 122. That is, in the present embodiment, the writing of log information in the non-volatile recording medium 121 or 122 is performed in real time following the occurrence of writing the log information in the main memory 106 rather than at a periodical timing or the like as in the comparative technology.

The environment in which the control device 100 (CM) according to the present embodiment is applied, that is, the configuration of the storage device 1 is as follows (see FIG. 1). That is, in the storage device 1, the CMs 100 (controllers) are multiplexed, and log information of the storage device 1 is held by each CM 100 to be stored in multiplexing.

Each CM 100 has two kinds of non-volatile recording media 121 and 122 having different performances. The first non-volatile recording medium 121 is a non-volatile second memory area that memorizes log information, and is a medium (e.g., an SSD or a USB memory) that is capable of storing therein a large amount of data but has a write life limit as described above. The second non-volatile recording medium 122 also serves as a non-volatile second memory area that stores therein monitor-control information exchanged to/from a FPGA 110 of the counterpart CM 100, and also memorizes log information. The second non-volatile recording medium 122 is a medium that has a small capacity but has substantially no write life limit (e.g., a medium having a write limit count higher than a predetermined number), and is, for example, a MRAM as described above.

Each CM 100 includes a large scale integration (LSI) or the like that is capable of performing both a monitor-control of the storage device 1 on the basis of the monitor-control information, and a write control of log information in the non-volatile recording medium 121 or 122. In the present embodiment, for example, the FPGA 110 is used as such an LSI.

In such an environment, the FPGA 110 of each CM 100 operates as follows.

During a normal operation of the storage device 1, upon receiving interrupt information notifying of an occurrence of log information (i.e., writing of log information in the main memory 106) from the CPU 105, the FPGA 110 reads the log information from the main memory 106.

When an abnormality occurs in the storage device 1, the FPGA 110 detects an occurrence of the abnormality on the basis of the monitor-control information and reads the log information from the main memory 106.

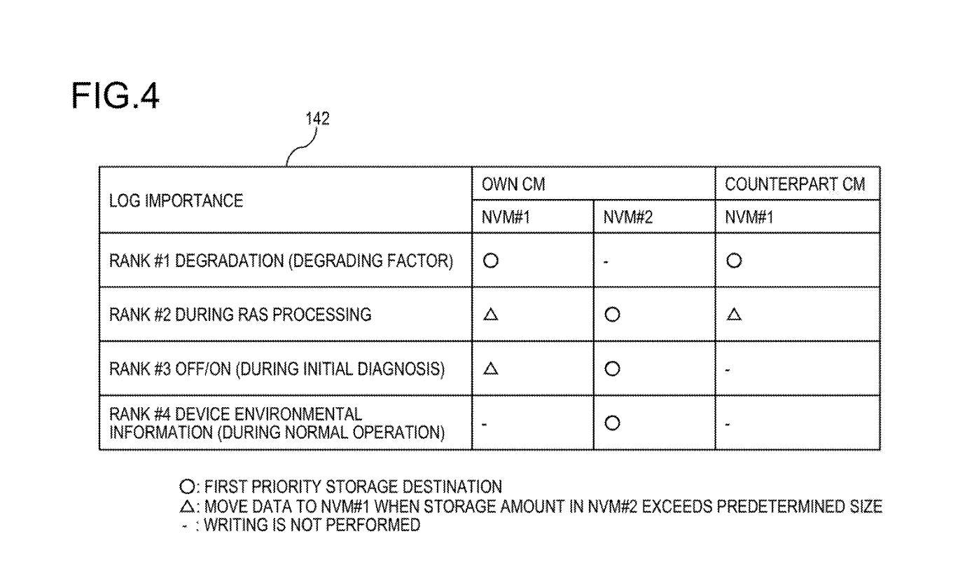

At the normal operation or the abnormality occurrence, upon reading the log information as described above, the FPGA 110 determines an importance (rank) of the read log information on the basis of a device state. In the present embodiment, for example, the importance of the log information is divided into four ranks #1 to #4 as described below with reference to FIGS. 3 and 4. The importance of rank #1 is the highest, the importance of rank #2 is second highest, the importance of rank #3 is third highest, and the importance of rank #4 is the lowest.

When the importance of the log information read from the main memory 106 is rank #1, the FPGA 110 writes the read log information in the NVM #1, and transmits the read log information to an FPGA 110 of a CM 100 as the redundant counterpart via the second communication path 132. Upon receiving the log information via the second communication path 132, the FPGA 110 of the CM 100 as the redundant counterpart writes the received log information in the NVM #1 to store the log information in duplicate.

When the importance of the log information read from the main memory 106 is rank #2, the FPGA 110 writes the read log information in the NVM #2. When the amount of the log information with rank #2 in the NVM #2 exceeds a predetermined amount (a write threshold), the FPGA 110 writes the predetermined amount of log information with rank #2 to the NVM #1 from the NVM #2, and transmits the log information to an FPGA 110 of the CM 100 as the redundant counterpart via the second communication path 132. Upon receiving the log information via the second communication path 132, the FPGA 110 of the CM 100 as the redundant counterpart writes the received log information in the NVM #1 to store the log information in duplicate. Thereafter, in the area of the NVM #2, in which the predetermined amount of log information with rank #2 is stored, new log information is written.

When the importance of the log information read from the main memory 106 is rank #3, the FPGA 110 writes the read log information in the NVM #2. When the amount of the log information with rank #3 in the NVM #2 exceeds a predetermined amount (a write threshold), the FPGA 110 writes the predetermined amount of log information with rank #3 from the NVM #2 to the NVM #1. Thereafter, in the area of the NVM #2, in which the predetermined amount of log information with rank #3 is stored, new log information is written.

When the importance of the log information read from the main memory 106 is rank #4, the FPGA 110 writes the read log information in the NVM #2. In the NVM #2, a predetermined area for storing log information with rank #4 is secured. When the amount of the log information with rank #4 exceeds a predetermined amount (a write threshold), the FPGA 110 overwrites old log information with new log information to store the new log information in the area for rank #4. Accordingly, with regard to the log information with rank #4, a predetermined amount of latest log information is stored in the area for rank #4 in the NVM #2.

As described above, according to the present embodiment, a write control (e.g., a control of a write amount) in the two non-volatile recording media 121 and 122 is performed by varying a storage destination of log information or multiplexing or non-multiplexing of log information in accordance with the rank of the importance of the log information. Accordingly, while suppressing the number of times of writing in the NVM #1 having a write life limit, the log information may be securely stored in the NVM #1 in duplicate in order of an importance.

In particular, at the normal operation of the storage device 1, due to the above-described control, the write amount of log information in the first non-volatile recording medium 121 having a write life limit may be reduced, and a large amount of log information may be securely stored in the first non-volatile recording medium 121 without exceeding a write life limit. The writing of log information in the first non-volatile recording medium 121 is not dependent on the FW processing unlike in the comparative technology, and thus may be performed in real time following the occurrence of writing the log information in the main memory 106 rather than at a periodical timing or the like.

When an abnormality occurs in the storage device 1, since the FPGA 110 reads log information from the main memory 106, the log information of the storage device 1 may be acquired even in a state where the CPU 105 is hanging up. Accordingly, even when the abnormality occurs in the storage device 1, the log information may be securely acquired.

As described above, following the occurrence of writing the log information in the main memory 106, writing of log information in the first non-volatile recording medium 121 is performed in real time. Therefore, unlike in the comparative technology, a log saving operation becomes unnecessary in the present embodiment when the storage device 1 is turned off or rebooted so that the turning-off or rebooting of the storage device 1 may be performed in a short time.

Hereinafter, descriptions will be made on a functional configuration of the control device 100 (CM) according to the present embodiment with reference to FIGS. 2 to 4. FIG. 2 is a diagram illustrating an example of a functional configuration of the CM 100. FIG. 3 is a diagram illustrating a specific example of a table (the first table 141) that associates a log type with a log importance according to the present embodiment. FIG. 4 is a diagram illustrating a specific example of a table (the second table 142) that associates a log importance with a write technique according to the present embodiment.

In each CM 100 according to the present embodiment, as illustrated in FIG. 2, the CPU 105 (the first processing unit) executes the control program 160, thereby serving as the log occurrence interrupt notification unit 152. The control program 160 is stored in, for example, the memory 106.

In each CM 100 of the present embodiment, as illustrated in FIG. 2, the FPGA 110 (the second processing unit) executes the control program 140, thereby serving as a log occurrence determination unit 111, an abnormality occurrence determination unit 112, and a write control unit 113. In the FPGA 110, as described above, the control program 140, the first table 141 and the second table 142 are embedded.

The control programs 160 and 140, the first table 141 and the second table 142 are provided in a form recorded in a non-transitory computer-readable recording medium. As the recording medium, a magnetic disk, an optical disk, a magneto-optical or the like may be exemplified. As the optical disk, a compact disk (CD), a digital versatile disk (DVD), a Blu-ray disk, or the like may be exemplified. The CD includes a CD read-only memory (ROM), a CD-recordable/rewritable (R/RW), and the like. The DVD includes a DVD-RAM, a DVD-ROM, a DVD-R, a DVD+R, a DVD-RW, a DVD+RW, a high definition (HD) DVD, and the like.

Here, the CPU 105 may read the control program 160 from the recording medium as described above and store the control program 160 in an internal memory device (e.g., the memory 106 or the flash memory 107) or an externally attached memory device and use the control program 160 therefrom. The CPU 105 may receive the control program 160 through a network (not illustrated), and store the control program 160 in an internal memory device or an externally attached memory device to use the control program 160 therefrom. The control program 140, the first table 141, and the second table 142 may be embedded in the FPGA 110 in advance, or may be provided by a non-transitory recording medium or the like to be installed from the recording medium or the like.

The CPU 105 includes a CPU-status (C-STS) register 151 and has a function as the log occurrence interrupt notification unit 152.

In the C-STS register 151, for example, the information to be described below is set so that an occurrence or a non-occurrence of log information is managed by the CPU 105. When the CPU 105 writes new log information in the main memory 106 (the first memory area), that is, when new log information occurs, information indicating that log is present (“log present”) is set in the C-STS register 151. Meanwhile, when the log information stored in the main memory 106 is written in the non-volatile recording medium 121 or 122 (the second memory area), information indicating that no log is present (“log absent”) is set in the C-STS register 151.

When the new log information is written in the main memory 106 (the first memory area), that is, when the new log information occurs, the log occurrence interrupt notification unit 152 notifies interrupt information (an interrupt message) to the FPGA 110.

The FPGA 110 has a FPGA-status (F-STS) register 114 and also has functions as the log occurrence determination unit 111, the abnormality occurrence determination unit 112, and the write control unit 113. Hereinafter, the log occurrence determination unit 111, the abnormality occurrence determination unit 112, the write control unit 113, and the F-STS register 114 will be described.

In the F-STS register 114, for example, information to be described below is set so that a write status of log information is managed by the FPGA 110. When the FPGA 110 reads log information from the main memory 106, the in-execution information (“Run”) indicating that the log information is being written is set in the F-STS register 114. Meanwhile, when the operation related to the writing of the log information is completed, idle information (“Idle”) indicating an idle state where the log information is not being written is set in the F-STS register 114.

The log occurrence determination unit 111 determines whether log information of the storage device 1 to be controlled is memorized in the main memory 106, that is, whether new log information has occurred. In the present embodiment, when receiving an interrupt message from the log occurrence interrupt notification unit 152 of the CPU 105, the log occurrence determination unit 111 determines that new log information is memorized (has occurred) in the main memory 106.

The abnormality occurrence determination unit 112 determines whether an abnormality has occurred in the operation state of the storage device 1 on the basis of the monitor-control information of the storage device 1.

The write control unit 113 performs a control to write log information from the main memory 106 to the NVM #1 or the NVM #2 at the following write timing. The write timing is a timing when the log occurrence determination unit 111 determines that new log information is memorized in the main memory 106, or a timing when the abnormality occurrence determination unit 112 determines that an abnormality has occurred in the operation state of the storage device 1.

The write control unit 113 has functions as an importance determination unit 113a, a selection unit 113b, and a write amount determination unit 113c.

The importance determination unit 113a (a rank determination unit) determines the importance (in the present embodiment, one of ranks #1 to #4 to which the log information belongs) of the log information read from the main memory 106. In the present embodiment, the rank determination unit 113a refers to the read log information and the first table 141 illustrated in FIG. 3, and determines one of the ranks #1 to #4 to which the type (log type) of the read log information belongs, thereby determining the importance of the read log information.

The selection unit 113b selects and changes a technique of writing log information in the NVM #1 or the NVM #2, in accordance with the importance of the log information determined by the rank determination unit 113a. In the present embodiment, the selection unit 113b searches the second table 142 illustrated in FIG. 4 using the importance determined by the rank determination unit 113a as a key, thereby selecting a write technique appropriate to the importance. Accordingly, the write control unit 113 performs a write control of log information using the write technique selected by the selection unit 113b.

The write amount determination unit 113c is used when the write control unit 113 performs the write control of log information as described below, and determines whether the storage amount of log information written in the NVM #2 (the second non-volatile recording medium 122) exceeds a predetermined size (a predetermined amount, a write threshold).

According to the present embodiment, among a plurality (two in the present embodiment) of kinds of non-volatile recording media having different performances, a non-volatile recording medium appropriate to an importance of log information is selected as a second memory area, and the log information is written in the selected non-volatile recording medium. The plurality of kinds of non-volatile recording media having different performances include the NVM #1 having a write limit count equal to or less than a predetermined number (the recording medium 121 having a write life limit), and the NVM #2 having a write limit count higher than the predetermined number (the recording medium 122 having substantially no write life limit).

The selection unit 113b selects either one of the NVM #1 and the NVM #2 as the second memory area in accordance with the importance of the log information. The write control unit 113 writes the log information in the NVM #1 or NVM #2 selected by the selection unit 113b. When the log information is written in the NVM #2, the write amount determination unit 113c determines whether the storage amount of the log information stored in the NVM #2 exceeds a predetermined size. When it is determined that the storage amount of the log information exceeds the predetermined size, the write control unit 113 performs a control to move log information stored in the NVM #2 to the NVM #1.

According to the present embodiment, the FPGA 110 is coupled to a NVM #1 of a counterpart CM 100b that forms a redundant configuration together with its own CM 100a, through the second communication path 132 and an FPGA 110 of the counterpart CM 100b. The selection unit 113b may select the NVM #1 in the counterpart CM 100b as a second memory area in accordance with the importance of the log information. Then, the write control unit 113 of its own CM 100a performs a control to write the log information in the selected NVM #1 of the counterpart CM 100b through the second communication path 132. In the present embodiment, descriptions have been made on a case where the NVM #1 of the counterpart CM 100b is selected as a second memory area, but the NVM #2 of the counterpart CM 100b may be selected as a second memory area.

Hereinafter, a specific example of the first table 141 and the second table 142 will be described with reference to FIGS. 3 and 4, and a technique, which is selected and performed on the basis of the second table 142 illustrated in FIG. 4, of writing log information in the NVM #1 or NVM #2 will be described.

As illustrated in FIG. 3, the first table 141 is a table that associates a type (log type) of log information with a rank (log importance) of log information. In the first table 141, the importance of the log information is divided into, for example, four ranks #1 to #4. Then, for example, log types, such as “Degrade/Alarm”, “Panic”, “Degrade factor”, and “Error”, correspond to rank #1 with the highest importance. The log types, such as “Recovered Error”, “Rebuild Copy back”, “Copy Session”, and “Environment”, correspond to rank #2 with a second highest importance. The log type of “Power” corresponds to rank #3 with a third highest importance. The log types, such as “Operation”, “Event”, “FRU Information2, and “Other”, correspond to rank #4 with the lowest importance.

As illustrated in FIG. 4, the second table 142 is a table that associates the rank (log importance) of log information with a technique of writing the log information by the FPGA 110.

The log type belonging to rank #1 corresponds to a type of log information occurring due to, for example, a degradation state (a degrade factor), that is, a state where a power of one CM 100 is lost, and is recognized as a log type with the highest importance. Therefore, when an importance of the read log information is rank #1, as illustrated in FIG. 4, the FPGA 110 (the write control unit 113) writes, with the highest priority, the read log information in the NVM #1 of its own CM 100. The FPGA 110 (the write control unit 113) transmits the read log information to the FPGA 110 of the counterpart CM 100 through the second communication path 132. Upon receiving the log information through the second communication path 132, the FPGA 110 (the write control unit 113) of the counterpart CM 100 writes, with the highest priority, the received log information in the NVM #1 store the log information in duplicate. The FPGA 110 (the write control unit 113) does not write the read log information in the NVM #2.

The log type belonging to rank #2 corresponds to a type of log information occurring due to, for example, remote access service (RAS) processing in a state during repair, that is, a state just prior to a degradation occurrence (a soft error occurrence state), and is recognized as a log type with a second highest importance behind the degradation state. Therefore, when the importance of the read log information is rank #2, as illustrated in FIG. 4, the FPGA 110 (the write control unit 113) writes the read log information in the NVM #2 first. Then, when the storage amount of the log information with rank #2 in the NVM #2 exceeds a predetermined size (a predetermined amount, a write threshold), the FPGA 110 (the write control unit 113) moves the predetermined size of log information with rank #2 from the NVM #2 to the NVM #1, and transmits the predetermined size of the log information with rank #2 to the FPGA 110 of the counterpart CM 100 through the second communication path 132. Upon receiving the log information through the second communication path 132, the FPGA 110 (the write control unit 113) of the counterpart CM 100 writes the received log information in the NVM #1 to store the log information in duplicate. Thereafter, in the area of the NVM #2, in which the predetermined size of log information with rank #2 is stored, is overwritten with new log information.

The log type belonging to rank #3 corresponds to a type of log information occurring due to, for example, OFF/ON (during initial diagnosis), and is recognized as a log type with a third highest importance behind the RAS processing state. Therefore, when the importance of the read log information is rank #3, as illustrated in FIG. 4, the FPGA 110 (the write control unit 113) writes the read log information in the NVM #2 first. Then, when the storage amount of the log information with rank #3 in the NVM #2 exceeds a predetermined size (a predetermined amount, a write threshold), the FPGA 110 (the write control unit 113) moves a predetermined size of log information with rank #3 from the NVM #2 to the NVM #1. Here, the FPGA 110 (the write control unit 113) does not write the read log information in the NVM #1 of the counterpart CM 100. Thereafter, in the area of the NVM #2, in which the predetermined size of log information with rank #3 is stored, is overwritten with new log information.

The log type belonging to rank #4 corresponds to a type of log information related to, for example, device environmental information (during normal operation), and is recognized as a log type with the lowest importance. Therefore, when the importance of the read log information is rank #4, as illustrated in FIG. 4, the FPGA 110 (the write control unit 113) writes the read log information in the NVM #2. Here, the FPGA 110 (the write control unit 113) does not move the log information with rank #4 from the NVM #2 to the NVM #1, and does not write the log information in the NVM #1 of the counterpart CM 100. In the NVM #2, a predetermined area for storing log information with rank #4 is secured as described above. When the storage amount of the log information with rank #4 exceeds the predetermined size, the FPGA 110 (the write control unit 113) overwrites old log information with new log information to store the new log information in the area for rank #4. Accordingly, with regard to the log information with rank #4, the predetermined amount of latest log information is stored in the area for rank #4 in the NVM #2.

In the NVM #2, log information with ranks #2 to #4 are stored separately for each rank. Here, a ratio of a capacity of an area for storing log information with rank #2 and rank #3 to a capacity of an area for storing log information with rank #4 may be set as, for example, 5:1. This is because there is no problem as long as only latest log information with rank #4 remains, and thus a capacity of an area for storing log information with rank #4 may be smaller than a capacity of an area for storing log information with rank #2 and rank #3.

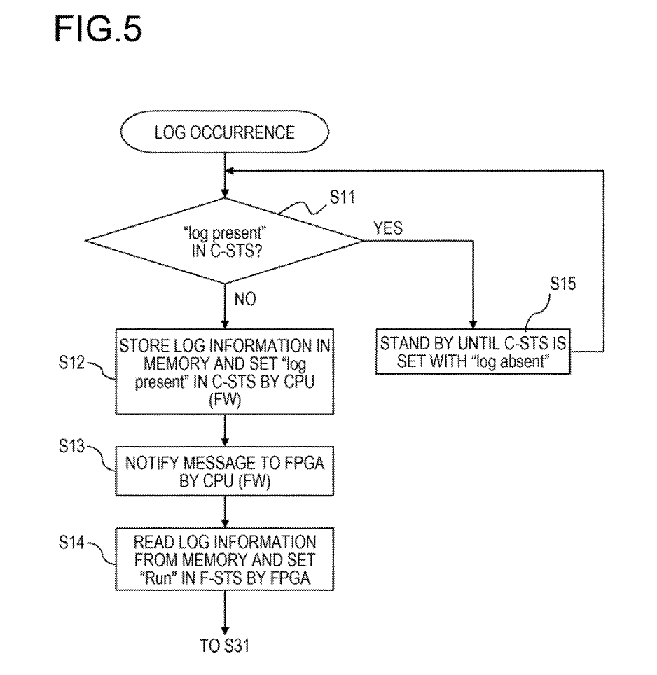

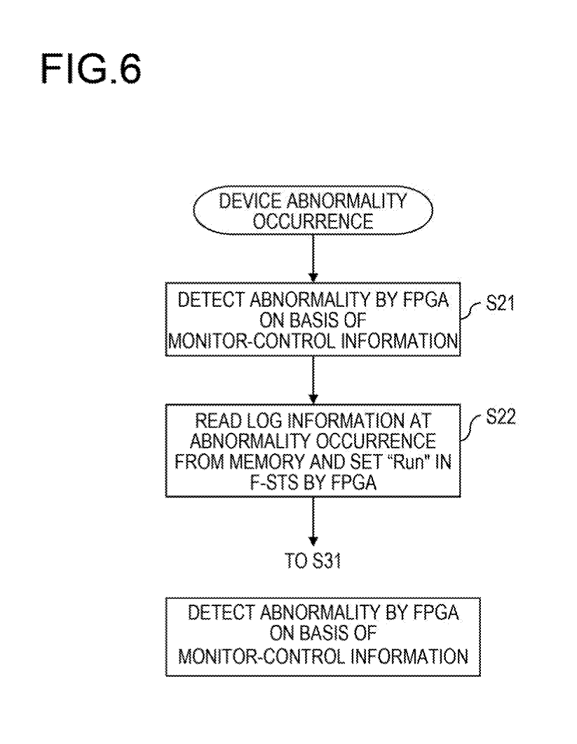

Hereinafter, descriptions will be made on an operation of the CM 100 in the storage device 1 according to the present embodiment configured as described above, with reference to flowcharts illustrated in FIGS. 5 to 7.

In the comparative technology, a write control of log information is performed only by the CPU 105 (FW). Thus, there is no problem as long as the FW operates. However, in the present embodiment, a write control of log information is performed by the monitor-control FPGA 110. Therefore, in the present embodiment, the C-STS register 151 capable of setting a state of the CPU 105 (information on whether log information has occurred) and the F-STS register 114 capable of setting a state of the FPGA 110 (information on whether log information is being written) are used. As in the comparative technology, in the main memory 106, a memory area (the first memory area) for log information is secured.

When the log information occurs at a normal operation of the storage device 1, the CPU 105 (FW) determines whether a “log present” is already set in the C-STS register 151 (S11). When it is determined that the “log present” is already set (YES in S11), the CPU 105 determines that the FPGA 110 is performing writing on the log information that has occurred in the previous time, and stands by until the C-STS register 151 is placed in a state of “log absent” (S15).

When it is determined that the “log present” is not set in the C-STS register 151 (NO in S11), that is, when the FPGA 110 is not performing writing on the log information, the CPU 105 (FW) performs operations of S12 and S13. In S12, the CPU 105 (FW) stores new log information in the main memory 106 (the first memory area), and sets the “log present” in the C-STS register 151. In S13, the log occurrence interrupt notification unit 152 of the CPU 105 (FW) notifies an interrupt message to the FPGA 110.

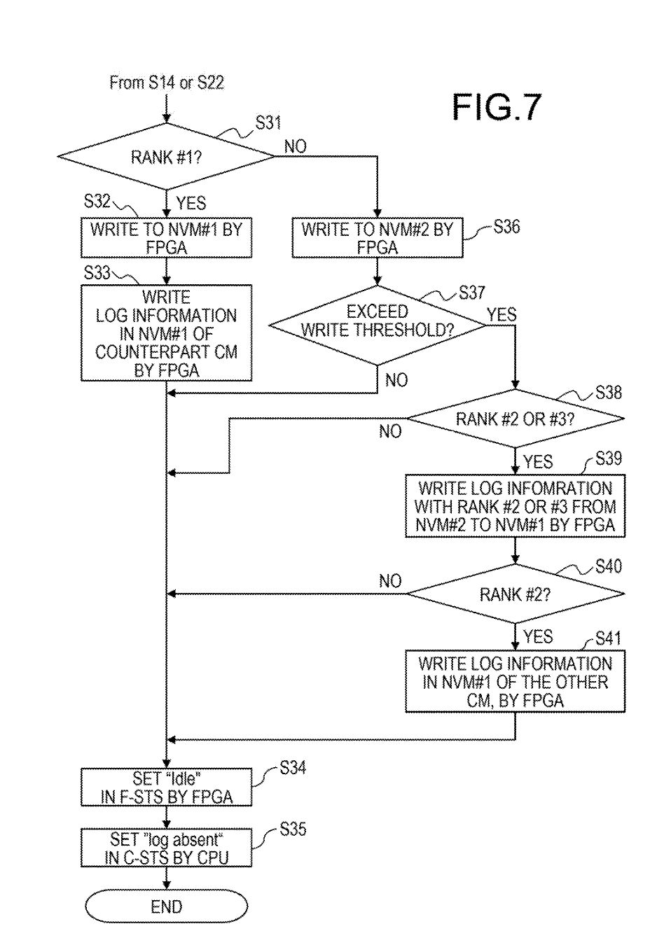

When notified of the interrupt message from the CPU 105, the log occurrence determination unit 111 of the FPGA 110 determines that new log information has occurred. Then, the FPGA 110 reads the log information in the main memory 106 (the first memory area) in an order from a top address, and sets “Run” in the F-STS register 114 (S14). Thereafter, the FPGA 110 proceeds to S31 in FIG. 7 to perform write control processing.

Meanwhile, when an abnormality occurs in the storage device 1, the abnormality occurrence determination unit 112 of the FPGA 110 detects that an abnormality has occurred in an operation state of the storage device 1 on the basis of the monitor-control information of the storage device 1 (S21).

When an abnormality occurrence is detected, the FPGA 110 reads the log information in the main memory 106 (the first memory area), which is believed to include log information related to a cause of the abnormality occurrence, in an order from the top address. Then, the FPGA 110 sets “Run” in the F-STS register 114 (S22). Thereafter, the FPGA 110 proceeds to S31 in FIG. 7 to perform the write control processing.

In the write control processing illustrated in FIG. 7, first, the rank determination unit 113a of the FPGA 110 determines whether an importance of the log information read from the memory 106 is rank #1 (S31). When it is determined that the importance is rank #1 (YES in S31), the write control unit 113 of the FPGA 110 writes the log information read from the memory 106 in the NVM #1 (S32). Thereafter, the write control unit 113 transmits the log information read from the memory 106 to the FPGA 110 of the counterpart CM 100 through the second communication path 132 and writes the log information in the NVM #1 of the counterpart CM 100 to store the log information in duplicate (S33).

When the operation related to writing of the log information is completed, the FPGA 110 sets “Idle” in the F-STS register 114 (S34), the CPU 105 (FW) sets “log absent” in the C-STS register 151 (S35), and the process is ended. When new log information occurs in a state where “Run” is set in the F-STS register 114 (that is, a state where log information is being written), the CPU 105 stores the log information in the memory 106 after standing by until “Idle” is set in the F-STS register 114.

When it is determined that the importance of the log information read from the memory 106 is not rank #1 (NO in S31), that is, when the importance is any one of ranks #2 to #4, the write control unit 113 writes the log information read from the memory 106 in the NVM #2 (S36).

When the log information is written in the NVM #2, the write amount determination unit 113c of the FPGA 110 determines whether the storage amount of the log information written in the NVM #2 exceeds a predetermined size (a write threshold) (S37). When it is determined that the storage amount of the log information does not exceed the predetermined size (NO in S37), the FPGA 110 proceeds to S34.

When it is determined that the storage amount of the log information exceeds the predetermined size (YES in S37), the rank determination unit 113a determines whether the importance of the log information read from the memory 106 is rank #2 or #3 (S38). When it is determined that the importance is not rank #2 nor #3, that is, the importance is rank #4 (NO in S38), the FPGA 110 proceeds to S34 while leaving only a predetermined size of latest log information in the NVM #2.

When it is determined that the importance is rank #2 or #3 (YES in S38), the write control unit 113 moves a predetermined size of log information with rank #2 or #3 from the NVM #2 to the NVM #1 (S39).

After moving the log information from the NVM #2 to the NVM #1, the rank determination unit 113a determines whether the importance of the log information read from the memory 106 is rank #2 (S40). When it is determined that the importance is not rank #2, that is, the importance is rank #3 (NO in S40), the FPGA 110 proceeds to S34.

When it is determined that the importance is rank #2 (YES in S40), the write control unit 113 transmits the log information read from the memory 106 to the FPGA 110 of the counterpart CM 100 through the second communication path 132 and writes the log information in the NVM #1 of the counterpart CM 100 to store the log information in duplicate (S41). Thereafter, the FPGA 110 proceeds to S34.

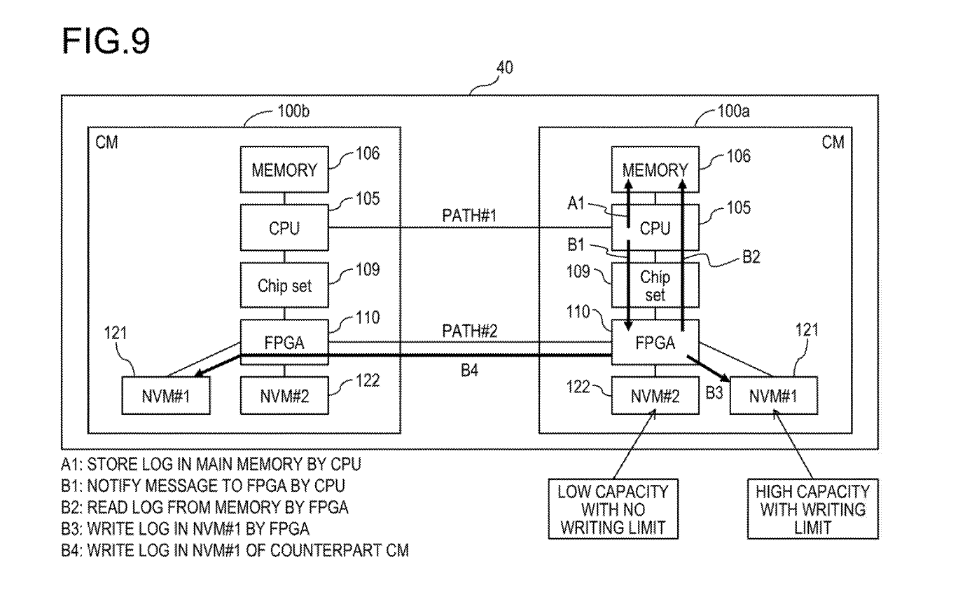

By performing the write control processing as described above with reference to the flowchart illustrated in FIG. 7, the writing controls on log information with ranks #1 to #4 are performed as illustrated in FIGS. 9 to 12, respectively. In FIGS. 9 to 12, a processing sequence in a case where log information has occurred at a normal operation of the storage device 1 is illustrated.

Hereinafter, descriptions will be made on a flow of a log with rank #1 according to the present embodiment with reference to FIG. 9.

When new log information occurs, the CPU 105 (FW) of the CM 100a temporarily stores the log information in the log information storage area 162 in the main memory 106 (A1 in FIG. 9). Subsequently, the CPU 105 (FW) notifies an interrupt message to the FPGA 110 (B1 in FIG. 9).

When notified of the interrupt message from the CPU 105 (FW), the FPGA 110 reads the log information from the main memory 106 (B2 in FIG. 9). Then, the FPGA 110 writes the read log information in the NVM #1 (B3 in FIG. 9) and writes the read log information in the NVM #1 of the counterpart CM 100 through the path #2 to store the log information in duplicate (B4 in FIG. 9).

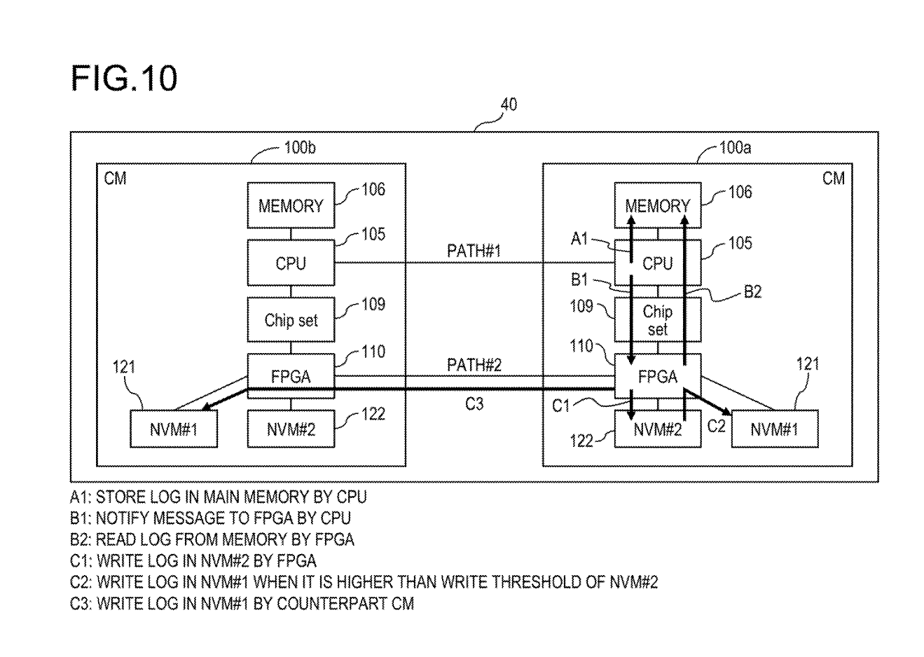

Hereinafter, descriptions will be made on a flow of a log with rank #2 according to the present embodiment with reference to FIG. 10.

When new log information occurs, the CPU 105 (FW) of the CM 100a temporarily stores the log information in the log information storage area 162 in the main memory 106 (A1 in FIG. 10). Subsequently, the CPU 105 (FW) notifies an interrupt message to the FPGA 110 (B1 in FIG. 10).

When notified of the interrupt message from the CPU 105 (FW), the FPGA 110 reads the log information from the main memory 106 (B2 in FIG. 10). Then, the FPGA 110 writes the read log information in the NVM #2 (C1 in FIG. 10). Here, when the storage amount of the log information with rank #2 in the NVM #2 exceeds a write threshold, the FPGA 110 writes a predetermined size of log information with rank #2 from the NVM #2 to the NVM #1. (C2 in FIG. 10). Then, the FPGA 110 writes the predetermined size of log information with rank #2 in the NVM #1 of the counterpart CM 100 through the path #2 to store the log information in duplicate (C3 in FIG. 10).

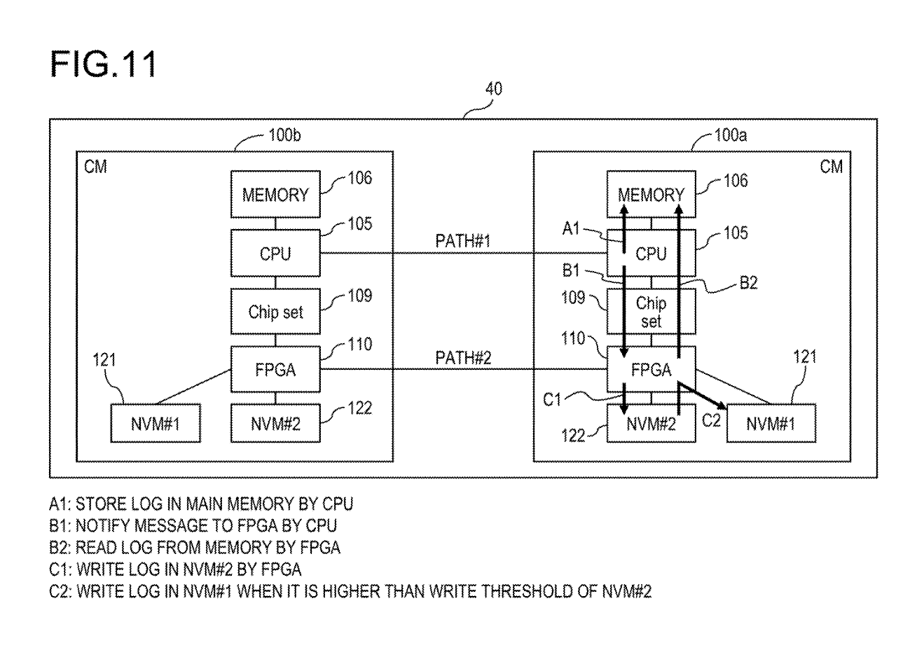

Hereinafter, descriptions will be made on a flow of a log with rank #3 according to the present embodiment with reference to FIG. 11.

When new log information occurs, the CPU 105 (FW) of the CM 100a temporarily stores the log information in the log information storage area 162 in the main memory 106 (A1 in FIG. 11). Subsequently, the CPU 105 (FW) notifies an interrupt message to the FPGA 110 (B1 in FIG. 11).

When notified of the interrupt message from the CPU 105 (FW), the FPGA 110 reads log information from the main memory 106 (B2 in FIG. 11). Then, the FPGA 110 writes the read log information in the NVM #2 (C1 in FIG. 11). Here, when the storage amount of the log information with rank #3 in the NVM #2 exceeds a write threshold, the FPGA 110 writes a predetermined size of log information with rank #3 from the NVM #2 to the NVM #1 (C2 in FIG. 11).

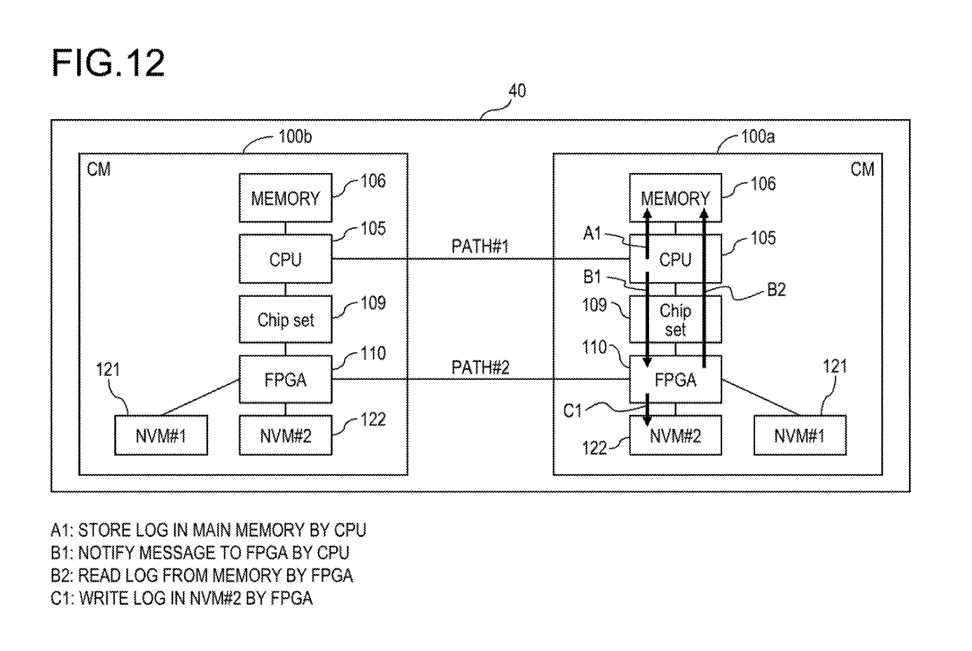

Hereinafter, descriptions will be made on a flow of a log with rank #4 according to the present embodiment with reference to FIG. 12.

When new log information occurs, the CPU 105 (FW) of the CM 100a temporarily stores the log information in the log information storage area 162 in the main memory 106 (A1 in FIG. 12). Subsequently, the CPU 105 (FW) notifies an interrupt message to the FPGA 110 (B1 in FIG. 12).

When notified of the interrupt message from the CPU 105 (FW), the FPGA 110 reads log information from the main memory 106 (B2 in FIG. 12). Then, the FPGA 110 writes the read log information in the NVM #2 (C1 in FIG. 12). Here, as described above, in the NVM #2, a predetermined area for storing log information with rank #4 is secured. When the storage amount of the log information with rank #4 exceeds a predetermined size, the FPGA 110 overwrites old log information with new log information to store the new log information in the area for rank #4. Accordingly, with regard to the log information with rank #4, a predetermined amount of latest log information is stored in the area for rank #4 in the NVM #2.

As described above, the monitor-control FPGA 110 of the control device 100 (CM) according to the present embodiment performs a write control of log information without depending on firmware processing by the CPU 105. Therefore, following an occurrence of writing log information in the main memory 106, writing of log information in the NVM #1 or the NVM #2 may be performed in real time rather than at a periodical timing or the like. Accordingly, at an abnormality occurrence of the storage device 1, the FPGA 110 may read log information from the main memory 106, and transmit the log information to the counterpart CM 100 through the second communication path 132. Therefore, even in a state where the CPU 105 is hanging up, the log information of the storage device 1 may be acquired and transmitted. Thus, even when the abnormality occurs in the storage device 1, the log information may be securely acquired and stored.

According to the present embodiment, by varying a storage destination of log information and by varying multiplexing or non-multiplexing of log information in accordance with the rank of the importance of the log information, a write control (e.g., a control of a write amount) in the two non-volatile recording media 121 and 122 (the NVM #1 and the NVM #2) is performed. Accordingly, while suppressing the number of times of writing in the NVM #1 having a write life limit, the log information may be securely stored in the NVM #1 in duplicate in order of an importance.

In particular, at the normal operation of the storage device 1, due to the above-described control, the write amount of log information in the NVM #1 having a write life limit may be reduced, and thus, a large amount of log information may be securely stored in the NVM #1 without exceeding the write life limit.

As described above, following an occurrence of writing log information in the main memory 106, writing of log information in the NVM #1 or NVM #2 is performed by the FPGA 110 in real time. Thus, when the storage device 1 is turned off or rebooted, latest log information is present in the NVM #1 or NVM #2. Therefore, a log saving operation as in the comparative technology becomes unnecessary, and a time for sweeping log information from the main memory 106 may be reduced or becomes 0 so that the turning-off or rebooting of the storage device 1 may be performed in a relatively short time.

The FPGA 110 performs a log management including a write control of log information, thereby reducing a load required for a log management in the CPU 105 (FW). The log information is written in the NVM #1 or NVM #2 from the main memory 106 in real time. Thus, it becomes not necessary to hold a large amount of log information in the main memory 106, and the main memory 106 may be effectively utilized for other user data processing or the like, thereby substantially improving the device performance.

In the present embodiment, a frequency or size of writing to the NVM #1 is controlled by the FPGA 110. Thus, with regard to the NVM #1, writing of log information with the lowest importance, i.e., rank #4 is omitted, and only sequential write processing of a predetermined size of log information with ranks #2 and #3 is performed from the NVM #2 to the NVM #1. Thus, a long life of the NVM #1 may be realized. The log information with the highest importance, i.e., rank #1, is immediately written in the NVM #1, and thus may be securely stored in the NVM #1.

The embodiment of the present disclosure has been described in detail. However, embodiments are not limited to the specific embodiment, but may be realized by being modified and changed in various ways within a scope not departing from the gist of the present embodiment.

In the embodiment described above, a case where two control devices (CMs) are provided has been described, but embodiments are not limited thereto. The present embodiment may be applied to a case where, for example, three or more control devices (CMs) are provided similarly to the embodiment described above, and similar operational effects as those of the above-described embodiment may be achieved.

In the above-described embodiment, a case where an information processing device to be controlled and monitored is a storage device has been described, but embodiments are not limited thereto. The present embodiment may be applied to, for example, an information processing device such as a server device or the like, similarly to the embodiment described above, and similar operational effects as those of the above-described embodiment may be achieved.

In the above-described embodiment, a case where a first processing unit is a CPU, and a second processing unit is an FPGA has been described, but embodiments are not limited thereto. The first processing unit may be any one of an FPGA, a micro processing unit (MPU), a digital signal processor (DSP), an application specific integrated circuit (ASIC), and a programmable logic device (PLD), instead of the CPU, and may be a combination of two or more elements of the CPU, the MPU, the DSP, the ASIC, the PLD, and the FPGA. Similarly, the second processing unit may be any one of a CPU, an MPU, a DSP, an ASIC, and a PLD instead of the FPGA, and may be a combination of two or more elements of the CPU, the MPU, the DSP, the ASIC, the PLD, and the FPGA.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A control device, comprising:
a first memory;
a first processor coupled to the first memory and the first processor configured to
store log information of an information processing device into the first memory;
a second memory; and
a second processor coupled to the second memory and the second processor configured to
determine whether the log information is stored in the first memory,
read the log information from the first memory when the second processor determines that the log information is stored in the first memory, and
write the read log information into the second memory.

2. The control device according to claim 1, wherein
the first processor is configured to
notify interrupt information to the second processor when the log information is stored in the first memory, and
the second processor is configured to
determine, upon receiving the interrupt information from the first processor, that the log information is stored in the first memory.

3. The control device according to claim 1, wherein
the second processor is configured to
obtain operation-state information by monitoring an operation state of the information processing device,
determine whether an abnormality has occurred in the operation state of the information processing device on basis of the obtained operation-state information,
read the log information from the first memory when the second processor determines that an abnormality has occurred in the operation state of the information processing device, and
write the read log information into the second memory.

4. The control device according to claim 1, wherein
the second processor is configured to
determine an importance of the log information, and
write the log information into the second memory in accordance with the determined importance of the log information.

5. The control device according to claim 4, wherein
the second processor is configured to
select, as the second memory, a non-volatile recording medium appropriate to the importance of the log information from among plural kinds of non-volatile recording media having different performances, and
write the log information into the selected non-volatile recording medium.

6. The control device according to claim 5, wherein
the plural kinds of non-volatile recording media include a first non-volatile recording medium having a write limit count equal to or less than a predetermined number and a second non-volatile recording medium having a write limit count higher than the predetermined number, and
the second processor is configured to
select one of the first non-volatile recording medium and the second non-volatile recording medium as the second memory in accordance with the importance of the log information,
write the log information into the selected non-volatile recording medium,
determine whether an amount of log information stored in the second non-volatile recording medium exceeds a predetermined threshold, and
move, when the second processor determines that the amount exceeds the predetermined threshold, log information stored in the second non-volatile recording medium to the first non-volatile recording medium.

7. The control device according to claim 4, wherein
the second processor is coupled to a non-volatile recording medium included in a counterpart device through a communication path, the counterpart device being configured to be redundant with the control device, and
the second processor is configured to
select the non-volatile recording medium as the second memory in accordance with the importance of the log information, and
write the log information into the selected non-volatile recording medium through the communication path.

8. A non-transitory computer-readable recording medium having stored therein a program that causes a first processor coupled to a first memory and a second processor coupled to a second memory to execute a process, the process comprising:
storing, by the first processor, log information of an information processing device into the first memory;
determining, by the second processor, whether the log information is stored in the first memory;
reading, by the second processor, the log information from the first memory when the second processor determines that the log information is stored in the first memory; and
writing, by the second processor, the read log information into the second memory.

9. The non-transitory computer-readable recording medium according to claim 8, the process further comprising:
notifying, by the first processor, interrupt information to the second processor when the log information is stored in the first memory; and
determining by the second processor, upon receiving the interrupt information from the first processor, that the log information is stored in the first memory.

10. The non-transitory computer-readable recording medium according to claim 8, the process further comprising:
obtaining, by the second processor, operation-state information by monitoring an operation state of the information processing device;
determining, by the second processor, whether an abnormality has occurred in the operation state of the information processing device on basis of the obtained operation-state information; and
reading, by the second processor, the log information from the first memory when the second processor determines that an abnormality has occurred in the operation state of the information processing device; and
writing, by the second processor, the read log information into the second memory.

11. The non-transitory computer-readable recording medium according to claim 8, the process further comprising:
determining, by the second processor, an importance of the log information; and
writing, by the second processor, the log information into the second memory in accordance with the determined importance of the log information.

12. The non-transitory computer-readable recording medium according to claim 11, the process further comprising:
selecting by the second processor, as the second memory, a non-volatile recording medium appropriate to the importance of the log information from among plural kinds of non-volatile recording media having different performances; and
writing, by the second processor, the log information into the selected non-volatile recording medium.

13. The non-transitory computer-readable recording medium according to claim 12, wherein
the plural kinds of non-volatile recording media include a first non-volatile recording medium having a write limit count equal to or less than a predetermined number and a second non-volatile recording medium having a write limit count higher than the predetermined number, and
the process further comprises:
selecting, by the second processor, one of the first non-volatile recording medium and the second non-volatile recording medium as the second memory in accordance with the importance of the log information;
writing, by the second processor, the log information into the selected non-volatile recording medium;
determining, by the second processor, whether an amount of log information stored in the second non-volatile recording medium exceeds a predetermined threshold; and
moving by the second processor, when the second processor determines that the amount exceeds the predetermined threshold, log information stored in the second non-volatile recording medium to the first non-volatile recording medium.

14. The non-transitory computer-readable recording medium according to claim 11, wherein
the second processor is coupled to a non-volatile recording medium included in a counterpart device through a communication path, the counterpart device being configured to be redundant with the control device, and
the process further comprises:
selecting, by the second processor, the non-volatile recording medium as the second memory in accordance with the importance of the log information; and
writing, by the second processor, the log information into the selected non-volatile recording medium through the communication path.

15. A control method, comprising:
storing, by a first processor, log information of an information processing device in a first memory coupled to the first processor;
determining, by a second processor, whether the log information is stored in the first memory;
reading, by the second processor, the log information from the first memory when the second processor determines that the log information is stored in the first memory; and
writing, by the second processor, the read log information into a second memory coupled to the second processor.

16. The control method according to claim 15, the control method further comprising:
notifying, by the first processor, interrupt information to the second processor when the log information is stored in the first memory; and
determining by the second processor, upon receiving the interrupt information from the first processor, that the log information is stored in the first memory.

17. The control method according to claim 15, the control method further comprising:
obtaining, by the second processor, operation-state information by monitoring an operation state of the information processing device;
determining, by the second processor, whether an abnormality has occurred in the operation state of the information processing device on basis of the obtained operation-state information;
reading, by the second processor, the log information from the first memory when the second processor determines that an abnormality has occurred in the operation state of the information processing device; and
writing, by the second processor, the read log information into the second memory.

18. The control method according to claim 15, the control method further comprising:
determining, by the second processor, an importance of the log information; and
writing, by the second processor, the log information into the second memory in accordance with the determined importance of the log information.

19. The control method according to claim 18, the control method further comprising:
selecting by the second processor, as the second memory, a non-volatile recording medium appropriate to the importance of the log information from among plural kinds of non-volatile recording media having different performances; and
writing, by the second processor, the log information into the selected non-volatile recording medium.

20. The control method according to claim 18, wherein
the second processor is coupled to a non-volatile recording medium included in a counterpart device through a communication path, the counterpart device being configured to be redundant with the control device, and
the control method further comprises:
selecting, by the second processor, the non-volatile recording medium as the second memory in accordance with the importance of the log information; and
writing, by the second processor, the log information into the selected non-volatile recording medium through the communication path.
